(19) United States
(12) Patent Application Publication
(10) Pub. No.: US 2010/0092261 A1
(43) Pub. Date: Apr. 15, 2010

(54) MILLING TOOL, IN PARTICULAR HAND MILLING MACHINE FOR MILLING BEVELS

(76) Inventor: Stephan Rieth, St. Wendel (DE)

Correspondence Address: FRIEDRICH KUEFFNER, 317 MADISON AVENUE, SUITE 910, NEW YORK, NY, 10017, US

(21) Appl. No.: 12/310,608

(22) PCT Filed: Aug. 28, 2007
(86) PCT No.: PCT/DE2007/001558

§ 371 Date: Jun. 1, 2009

(30) Foreign Application Priority Data
Aug. 28, 2006 (DE) 10 2006 040 090.9

(51) Int. Cl. B23C 1/20; B23C 9/00

(52) U.S. Cl. 409/182; 409/218

(57) ABSTRACT

The milling tool (1) has a spindle (2, 3), which is mounted in a housing (8) and carries a milling head (14) fitted with cutting inserts (15). Arranged in the drive train of the milling head (14) is a torque-transmitting resilient coupling (13). The spindle (2, 3) actually comprises spindle parts (2, 3) that are connected by a plug-in connection via a bearing bush (9, 10) and can be turned with respect to each other, and the coupling (13) is arranged between these spindle parts. The resilient coupling comprises a helical spring (13) that is fastened by each of its ends to a spindle part (2, 3). The milling head (14) is fitted with sharp-edged cutting inserts (15), which have a wedge angle of 40-75° and have on the milling head (14) a position in which they operate with a positive rake angle of at least 6° and a clearance angle of at least 6°.

The invention concerns a milling tool, especially a hand milling machine for milling bevels, with a spindle supported in a case, said spindle carrying a milling head fitted with cutting tips, and, in addition, especially with a guide stop to be placed against the workpiece, and possibly with an additional guide stop to be placed against the workpiece, said additional guide stop being perpendicular to the first guide stop. A milling tool of this type is disclosed, e.g., by WO 2005/095038 A2.

The objective of the invention is to increase the efficiency of the above milling tool.

In accordance with the invention, the solution to this problem is characterized by the fact that an elastic coupling that transmits the torque is mounted in the drive train of the milling head. In a variant of the invention, the milling tool is provided with an elastically operating drive motor, e.g., a pneumatic motor, or with a drive that has a control mechanism that cushions the driving force.

The force with which the workpiece opposes the milling head is subject to more or less large variations, which result from variations of the speed of advance, the material properties, vibrations, etc. Especially in the case of manual placement of the milling head against the workpiece, large, uneven forces arise. Naturally, in the further course of the milling work, variable forces are exerted, especially where hand milling machines are concerned. The elastic coupling provided by the invention absorbs the force peaks. Increases in force are reduced by the stressing of the elastic element; the energy stored in the spring in the process is then reintroduced into the milling operation, thereby evening out the variations in force.

Depending on the cutting conditions, the materials being machined, etc., spring excursions of a few minutes up to, e.g., 360°, can occur.

Since, in accordance with the invention, the disruptive force peaks are removed, on the whole greater force can be exerted, and thus the cutting speed, i.e., the metal removal capacity, can be increased.

At the same time, the smoothing of the variations in force protects the cutting tips, whose cutting edges experience more or less large amounts of breakoff due to impacts. The service life of the cutting tips increases relative to their performance.

In addition, the improved quiet running is an advantage to the whole milling tool. Its service life is also increased.

The quiet running also affects the workpiece in that a higher quality of the milled surface is achieved.

An especially advantageous refinement of the invention consists in the combination of the cushioned driving force and a fitting of the milling head with sharp-edged cutting tips, which have a wedge angle of 40-75° and preferably have a position on the milling head in which they operate with a positive rake angle of at least 6° and a clearance angle of at least 6°.

The slender, sharp, and aggressively cutting cutting tips make it possible to realize high cutting speeds, because the material offers it less resistance. However, its cutting edges are very sensitive to impacts.

These cutting tips designed and arranged as described above can thus be utilized to a much greater extent due to the evening out of the cutting force. A combination effect is produced.

In an advantageous embodiment of the invention, the spindle consists of spindle parts that are able to rotate relative to each other, and the spindle parts are connected by the coupling. Preferably, they are put together by a plug connection, in which they are flexurally rigid and can rotate relative to each other.

This results in a spindle that is more or less just as stiff as an undivided spindle; if necessary, in addition to pivot bearings installed near the ends of the spindle, the spindle can be provided with another pivot bearing in the vicinity of the plug connection. However, without an additional pivot bearing of this type, the whole milling tool can be kept shorter, which in itself is desirable.

On the other hand, however, it is also possible for at least the spindle part that supports the milling head to be completely supported near its two ends, and, if necessary, to support the other spindle part in the same manner, and to connect the spindle parts only by the elastic coupling that transmits the torque and without a plug connection.

In this design, in contrast to a continuous spindle, no vibrations are transmitted either from the motor to the cutting tips or from the cutting tips to the user holding the milling machine.

The spindle parts are preferably connected in the plug connection via a bearing bush, which increases the sliding ability for the rotation of the spindle parts relative to each other and for axial sliding due to thermal expansion of the two spindle parts.

The possibility of axial sliding offers other advantages. For example, inside axial miller infeed can be carried out with an adjusting rod that is guided by the spindle and supported in it, or it can be carried out with pressure control pneumatically or hydraulically. However, this means that the elastic coupling must allow axial displacement.

Accordingly, in a refinement of the invention, the axial position of the milling head relative to the guide stop, which in this case is rigidly seated on the case, and possibly to the drive train or parts of the drive train can be varied by a device that is mounted at least partly in the case, preferably by an adjusting rod that is axially rigidly connected with the milling head or by a pneumatic or hydraulic cylinder constructed in the drive train.

In accordance with an advantageous embodiment of the invention, the elastic coupling consists of a helical spring with its ends mounted on one spindle part each.

However, a wide variety of other designs is also possible here, including a body made of rubber.

The ends of the spring are preferably each clamped and/or adhesively bonded, soldered, or welded in a socket, which is formed in a nut screwed onto the spindle part.

The socket holds, for example, one to two windings of the spring.

Finally, one variant of the invention consists in a milling tool of a hand milling machine for milling bevels with a spindle supported in a case, said spindle carrying a milling head fitted with cutting tips, and, in addition, especially with a guide stop to be placed against the workpiece, and possibly with an additional guide stop to be placed against the workpiece, said additional guide stop being perpendicular to the first guide stop, wherein a flexible shaft is mounted in the drive train. The flexible shaft preferably connects the drive motor with the transmission unit of the milling tool.

The driving of tools via a flexible shaft with a length of, e.g., up to three meters, in itself is already well known, but without an advantage associated with elasticity of torsion having been recognized. The present invention in this respect consists in using the torsion spring characteristics of a flexible shaft for a hand milling machine for milling bevels, for which the cushioning driving force is advantageous to an especially high degree.

The drawings show a specific embodiment of the invention.

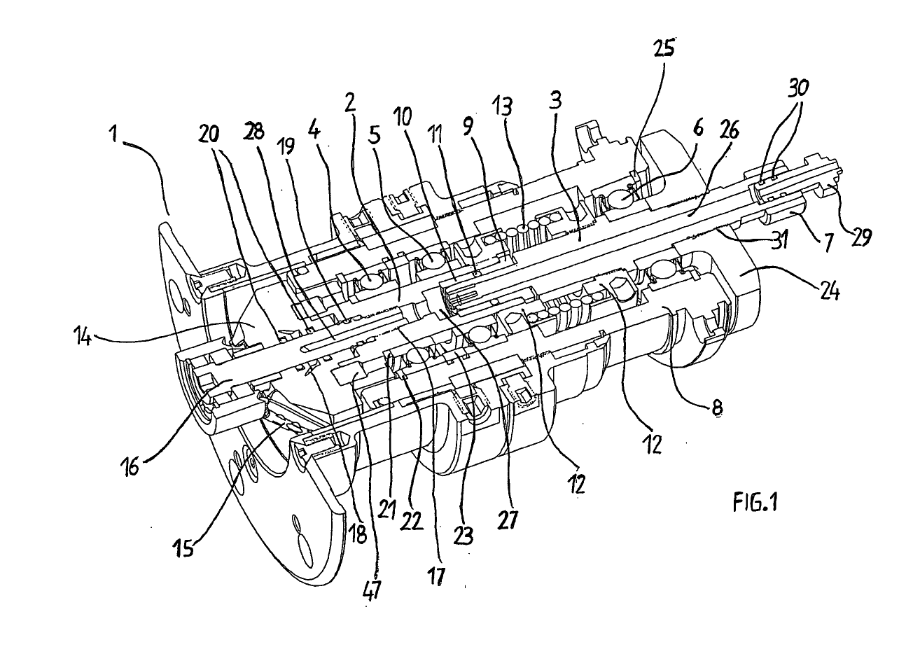

FIG. 1 is an isometric sectional view of a milling tool.

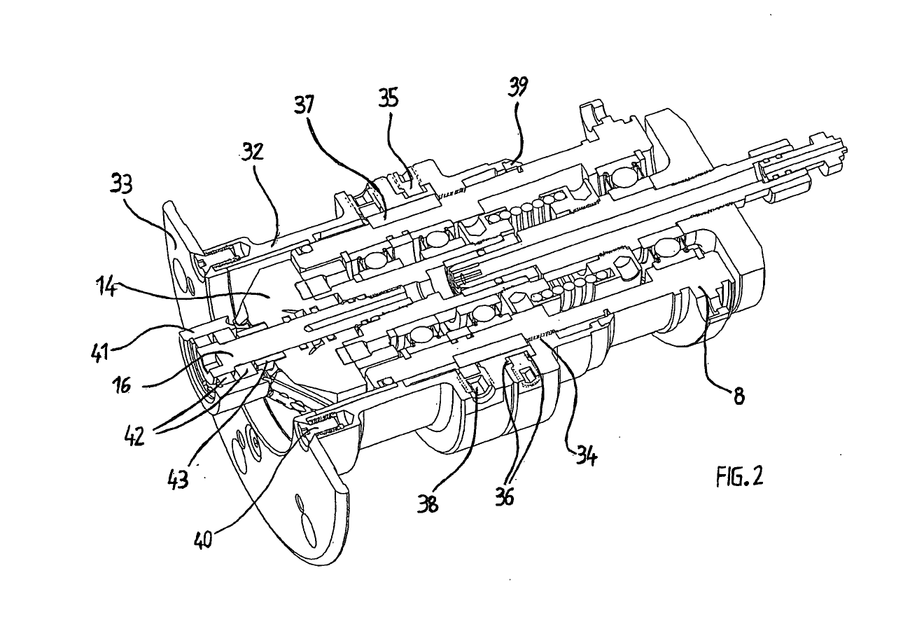

FIG. 2 is the same isometric sectional view of a milling tool with additional reference numbers.

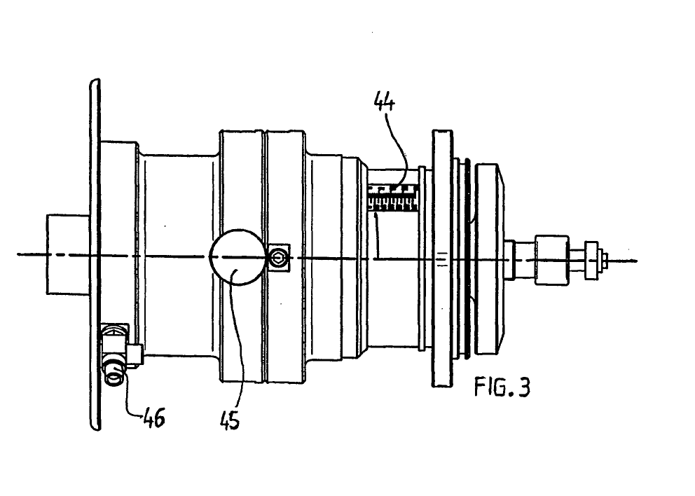

FIG. 3 is a side view of a milling tool.

FIG. 1 shows a milling tool 1 with two spindle parts 2 and 3. Spindle part 2 is supported with two bearings 4 and 5, and spindle part 3 is supported with a bearing 6 in the case 8 and with a bearing 7 in another part (not shown) of a milling machine.

In the axial direction, the bearings 4 and 5 are loosely supported on the spindle side and rigidly supported on the case side. An annular disk 21 is mounted on the bearing 4 as one-sided axial support of the spindle part 2. The bearing 4 is held on the case 8 with a Seger ring 22. Another ring 23 is arranged as a spacer between the bearings 4 and 5 on the case side, and on the other side, the bearing 5 rests against a shoulder of the case 8 on the case side.

The bearing 6 is supported in an axially rigid way on the side of the spindle part 3 between a shoulder of the spindle part 3 and a drive crown wheel 24, which is connected with the spindle part 3 by a thread 31, and it is supported in an axially rigid way on the side of the case 8 between an inner collar of the case 8 and a Seger ring 25.

The two spindle parts 2 and 3 are supported by bearing bushes 9 and 10 in such a way that they are flexurally rigid and can rotate relative to each other. The spindle part 3 is inserted in the spindle part 2 for this purpose. A gasket 11 is arranged between the two bearing bushes 9 and 10. Alternatively, a one-part bearing bush with grooves for gaskets can be inserted on both sides.

The milling tool 1 can also be built without the bearing 5. The spindle assembled by the plug connection of the spindle parts 2, 3 is then supported in the bearings 4.

In another alternative, the plug connection between the two spindle parts can be eliminated. The spindle part 2 is then supported by the bearings 4 and 5. The bearings 6 and 7 maintain the rotational stability of the spindle part 3.

A nut 12 is fastened on each of the spindle parts 2 and 3. The nuts 12 are located between the bearings 5 and 6. They have a socket, into which the ends of a helical spring 13 are clamped. The helical spring 13 constitutes a coupling that transmits the torque between the two spindle parts 2, 3. Spacers for the nuts 12 are provided in the case 8 to allow the initial stressing force of the spring 13 to be preset during assembly. A slip clutch or an electronic torque limiter can also be integrated here as a safety shutoff in the event of excessively high torque or overload.

A milling head 14 fitted with cutting tips 15 is mounted on the side of the spindle part 2 that faces away from the plug connection between the spindle parts 2 and 3. The milling head 14 is bolted to spindle part 2 by means of a fitted bolt 16, which screws into a thread 17 in the spindle part 2. In addition, driving pins 47 are inserted between the spindle part 2 and the milling head 14. These driving pins 47, which serve to drive the milling head 14, can also be designed a shear pins, which break above a certain load. They thus provide overload protection.

With suitable change in the design, the elastic coupling can also be arranged at this first point of connection of the drive train of the milling head.

To realize optimal cooling, the spindle parts 2, 3, the milling head 12 and the fitted bolt 16 are provided with cavities 26, 27, 28, in which a liquid is carried to the cutting tips 15. The cooling liquid is fed in through a feed device 29, which is rotatably seated in the spindle part 3. Channels 18 are provided in the milling head 14 from the cavity 28 to the reversible tips 15. Gaskets 30 are mounted between the spindle part 3 and the feed device 29. Another gasket 19 is inserted in a groove in the fitted bolt 16 between the fitted bolt 16 and the spindle part 2. Two additional gaskets 20 are inserted in grooves in the milling head 14 between the fitted bolt 16 and the milling head 14 for sealing around the channels 18.

The following discussion refers to FIG. 2. A guide plate 33 is provided for the axial guidance of the milling tool 1 on the workpiece. It is mounted by bolts 40 on an adjusting cap 32, which will be described in greater detail below. To achieve radial support, a guide roller 41 is connected by a bearing 42 and a bushing 43 with the fitted bolt 16 and the milling head 14. The bushing 43 adjusts the distance between the milling head 14 and the guide roller 41.

The adjusting cap 32 with the guide plate 33 is rotatably supported on the case 15 by a thread 34. The position of the adjusting cap 32 can be moved axially relative to the case 8 by turning it on the thread 34. FIG. 3 shows a scale 44 installed on the surface of the case 8. The scale 44 shows the position of the guide plate 33 relative to the case 8 and thus to the milling head.

Four driving pins 35 are installed in the adjusting cap 32 and project into a groove in the case 8. Said groove is provided with slide rings 36. In addition, four feather keys 37 are inserted in the case 8 to prevent torsion and as displacement guides. The position between the case 8 and the adjusting cap 32 can be locked with bolts 38. As FIG. 3 shows, a hand screw 45 is provided on the outside of the case for easier locking.

As protection against soiling from the outside, the thread 34 and the guide of the adjusting cap 32 are provided with a seal 39, which forms a seal with the case 8.

In addition, as FIG. 3 shows, a connecting device 46 for compressed air lines to an air jet is provided adjacent to the guide plate 33 on the adjusting cap 32. Lubricant is blown onto the cutting tips 15 through this connecting device 46. The cutting tips 15 are also cooled by the air.

In addition, the lubrication reduces friction between the workpiece and the cutting tips 15, which thus undergo less intense heating during the milling operation.

In an alternative, the guide plate 33 is rigidly joined directly with the case 8, and the adjusting cap 32 is replaced by an adjusting rod supported in the spindle 2, 3 to allow positioning. The adjusting rod is guided through the cavity 26 in the spindle part 3. It is rotatably supported in the cavity 27 of the spindle part 2. This adjusting rod makes it possible to change the position of the milling head relative to the guide plate 33, because the loose bearing of the spindle part 2 allows displacement in the axial direction. The adjusting rod thus makes it possible to move the spindle part 2 and the milling head 14 relative to the guide plate 33 against the restoring force produced by the spring 13. The spindle part 2 moves in the inner ring of the bearing 4 during this process. In this alternative, the milling tool 1 is built without the bearing 5.

In another alternative, the axial position of the milling head 14 is controlled hydraulically or pneumatically. The cavities 26, 27 are used to receive the pressure medium, which is supplied through a feed device 29. Analogously to the alternative embodiment described above, the spindle part 2, together with the milling head 14, can be moved in the axial direction by applying the medium pressure against the restoring force of the spring 13. When the pressure is reduced, the spindle part 2, together with the milling head 14, is pulled back again by the helical screw 13. Internal cooling is eliminated in this alternative. The fitted bolt 16 then has no inner bore 28, so that the space that contains the pressure medium is sealed from the outside. The cooling is produced by means of the air jet 46 in this case.

Before the start of milling with the milling tool 1, the desired degree of milling is set on the scale 44 with the adjusting cap 32, and the position is locked by means of the hand screw 54. To make the adjustment, the guide plate 33, together with the adjusting cap 32, is displaced relative to the case 8 and the milling head 14 by turning on the thread 34. The degree of milling can then be read from the scale 44. The adjusting cap 32 is locked down on the case with the locking screw 45 as soon as the desired position has been reached. The milling tool is then ready to use.

To machine an edge of a workpiece with the milling tool 1, the guide plate 33 is first placed on an edge on the surface of the workpiece to be milled. The milling head 14 is driven by means of the drive crown wheel 24 with a motor with a bevel gear that is mounted in the milling machine, in which the milling tool 1 is seated. Depending on the diameter of the milling head 14 and the desired cutting speed, the milling head 14 runs at a speed of 2,000 to 10,000 revolutions per minute. The milling proceeds at very high cutting speeds of 200-1,500 m/min. The drive crown wheel 24 turns the spindle part 3, which is coupled by the spring 13 with the spindle part 2 and the milling head 14 with the cutting tips 15.

The rotating milling head 14 is moved up to the edge, and the cutting tips 15 cut into the material. As the machining proceeds, the milling tool 1 is pushed against the workpiece until the guide roller 41 rests against the side of the edge. The bevel depth that was set with the scale 44 by adjustment of the adjusting cap 32 has then been reached. The edge is then machined along its length. In the case of hand-guided machines, the upmilling method is used. In the case of machines with mechanically assisted guidance, the upmilling method or the down milling method can be used.

The spring 13 used as a torque coupling between the spindle parts 2 and 3 yields when large loads are present on the cutting tips 15 and the milling head 14 and thus dampens the load. As soon as the loads on the milling head 14 decrease again during the machining process, the spring 13 moves back somewhat from its compressed position. It is thus able to dampen relatively large loads dynamically.

The spring constant of the spring 13 is selected in such a way that the high loads are just dampened, but the spring 13 is sufficiently stiff to transmit the rotational forces. If the cutting tips 15 are cooled and lubricated with a cooling or lubricating medium, the medium is fed into the milling tool 1 through the feed device 29. The cooling liquid is then guided through the cavity 26 in the spindle part 3, through the cavity 27 in the spindle part 2, and through the cavity 28 in the fitted bolt 16 and the channels 18 in the milling head to the cutting tips 15. The medium runs off to the outside over the cutting tips 15, which are cooled and lubricated in the process. The spindle parts 2 and 3 and the milling head 14 are additionally cooled from the inside.

1. A milling tool (1), especially of a hand milling machine for milling bevels, with a spindle (2, 3) supported in a case (8), said spindle carrying a milling head (14) fitted with cutting tips (15), and, in addition, especially with a guide stop (33 or 41) to be placed against the workpiece, and possibly with an additional guide stop (41 or 33) to be placed against the workpiece, said additional guide stop (41 or 33) being perpendicular to the first guide stop (33 or 41), wherein an elastic coupling (13) that transmits the torque is mounted in the drive train of the milling head (14).

2. A milling tool in accordance with claim 1, wherein the spindle (2, 3) consists of spindle parts (2, 3) that can rotate relative to each other and where the coupling (13) is disposed between them.

3. A milling tool in accordance with claim 2, wherein the spindle parts (2, 3) are put together by a plug connection, in which they are flexurally rigid and can rotate relative to each other.

4. A milling tool in accordance with claim 3, wherein the spindle parts (2, 3) are connected in the plug connection by bearing bushes (9 and 10).

5. A milling tool in accordance with claim 3, wherein, in addition to pivot bearings (4, 6) installed near the ends of the spindle, the spindle has another pivot bearing (5) in the vicinity of the plug connection.

6. A milling tool in accordance with claim 2, wherein at least the spindle part (2, 3) that supports the milling head (14) is supported in the case (8) near its two ends.

7. A milling tool in accordance with claim 1, wherein the elastic coupling consists of a helical spring (13) with its ends mounted on one spindle part (2, 3) each.

8. A milling tool in accordance with claim 7, wherein the ends of the spring are each clamped and/or adhesively bonded, soldered, or welded in a socket, which is formed in a nut (12) screwed onto the spindle part (2, 3).

9. A milling tool, especially of a hand milling machine for milling bevels, with a spindle (2, 3) supported in a case (8), said spindle carrying a milling head (14) fitted with cutting tips (15), and, in addition, especially with a guide stop (33 or 41) to be placed against the workpiece, and possibly with an additional guide stop (41 or 33) to be placed against the workpiece, said additional guide stop (41 or 33) being perpendicular to the first guide stop (33 or 41), wherein the milling tool (1) has an elastically operating drive, preferably a drive that has a control mechanism that cushions the driving force.

10. A milling tool of a hand milling machine for milling bevels, with a spindle supported in a case, said spindle carrying a milling head fitted with cutting tips, and, in addition, especially with a guide stop (33 or 41) to be placed against the workpiece, and possibly with an additional guide stop (41 or 33) to be placed against the workpiece, said additional guide stop (41 or 33) being perpendicular to the first guide stop (33 or 41), wherein a flexible shaft is mounted in the drive train.

11. A milling tool in accordance with claim 1, comprising the fitting of the milling head (14) with sharp-edged cutting tips (15), which have a wedge angle of 40-75° and preferably have a position on the milling head in which they operate with a positive rake angle of at least 5° and a clearance angle of at least 6°.
